(19) United States
(12) Patent Application Publication
(10) Pub. No.: US 2009/0115862 A1
(43) Pub. Date: May 7, 2009

(54) GEO-TAGGING OF MOVING PICTURES

(75) Inventor: Magnus ANDERSSON, Malmo (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/935,098

(22) Filed: Nov. 5, 2007

(51) Int. Cl. H04N 5/228; G06F 19/00

(52) U.S. Cl. 348/222.1; 701/300; 348/E05.031

(57) ABSTRACT

Image acquisition equipment for moving images comprising a sensing unit for registering moving images; a positioning receiver for receiving data indicative of the geographical position of the image acquisition equipment; a processing unit for calculating the current geographical position of the image acquisition equipment from the data received by the positioning receiver and for recording of moving images registered by the sensing unit; where processing unit is adapted for calculating the geographical position of the image acquisition equipment during the recording of moving images and for associating the current calculated geographical position with the current time of recording of the moving images.

A method for acquiring moving images according to the present invention is also described, where the method may be implemented by the image acquisition equipment for moving images as well as computer program which may execute the method steps. Also, the present invention describes a method for storing supplementary data related to recorded moving images.

### TECHNICAL FIELD

The present invention is related to the field of geographical marking of images.

### BACKGROUND OF THE INVENTION

Interactive map services on the Internet are enjoying a steep rise in popularity. By using Internet pages with searchable geographical maps a user may easily find the location of a certain street, building or even point of interest. Also, by using these map services, a user may easily obtain directions on how to get from point A to point B on the map. Several of these map services also offer different views of the earth, such as geographical map view, satellite view, hybrid view (hybrid view with map view overlayed) and other views. These other views may mark out places of interest, historical sites, airports, cultural heritage sites and other items.

Usually, the marked out items on the map are clickable and represented by one or more images.

Since some of the interactive map services are extendable with third party extensions some users of these services have introduced a so called geo-tagging function into the services. Geo-tagging may be best described as including metadata representing the latitude and longitude of a location where a photograph was taken in the digital image file representing the digital photograph. Metadata, in turn, may be defined as additional information added to a sound, image file or video which may be used for information purposes or for editing of these files.

A software using the interactive map service on the Internet will then mark out the coordinates provided in the metadata of the image file on the geographical map provided by the map service. Sometimes also the time when the photograph of the geographical location was taken can be included in the meta-tag.

Also, the software may display the geotags in the form of graphical symbols on the map, where the symbols are sometimes clickable offering the user a “real-world” picture of the geographical location.

However, all these interactive map services with geo-tagging functionality are inherently static. While some of the software using the interactive map services may provide so called “3D-flights” through some cities or points of interest, they mostly represent 3D-models with an image overlay in order to make the 3D-flight appear more realistic. Thus, they only approximate the real world.

The present invention aims at solving at least some of the disadvantages of known technology,

### SUMMARY OF THE INVENTION

One aspect of the present invention is related to an image acquisition equipment for moving images comprising a sensing unit for registering moving images, a positioning receiver for receiving data indicative of the geographical position of the image acquisition equipment, a processing unit for calculating the current geographical position of the image acquisition equipment from the data received by the positioning receiver and for recording of moving images registered by the sensing unit where the processing unit is adapted for calculating the geographical position of the image acquisition equipment during the recording of moving images and for associating the current calculated geographical position with the current time of recording of the moving images.

One advantage of the present invention is the ability to register the geographical position of a video recording and also geographical positions during a recording.

In one variant of the present invention the processing unit may be adapted to convert the calculated geographical position and the associated time of recording of the moving images to metadata. However, metadata need not exclusively consist of the calculated geographical position and the associated time of recording, but may also comprise the geographical height and the time of day. Moreover, the processing unit may be further adapted to add the metadata to the recording of moving images.

However, metadata may also be stored by the processing unit separately from the recording of moving images.

According to another variant of the present invention, the processing unit may be adapted to continuously add the metadata during the recording of moving images. One advantage of the continuous addition may be that a recording uploaded to a geographical map service may then be searchable not only from the beginning, but also in between the beginning and the end of the recording. Thus, a user may directly see the interesting part of the recording instead of being forced to see the entire recording of moving images.

However, according to another variant of the present invention, the processing unit may be adapted to intermittently add metadata during the recording of moving images. In this fashion, the processing unit may be adapted for adding metadata about the geographical position of the image acquisition equipment and the time of recording when for example a user of the image acquisition equipment is standing still a predefined amount of time, because this might be an indication of something catching his attention and being worth recording.

The recorded moving images may be for example stored in a memory of the image acquisition equipment, where the memory may be internal or external, as preferred. In either case, the processing unit may be adapted for storing the moving images and the metadata as a single data file in the memory of the image acquisition equipment. However, metadata and the recorded moving images may also be stored in separate data files in the memory.

In a further variant of the present invention, the image acquisition equipment may comprise a user interface for instructing the processing unit to calculate the geographical position of the image acquisition equipment and for associating the calculated geographical position to the time of recording of the moving images. One way of realizing the user interface may be by means of one or more functional buttons and/or a text and graphical user interface.

In one other variant of the present invention the image acquisition equipment may further comprise a receiver/transmitter combination for receiving and sending signals in a wireless communication network. Not only would the receiver/transmitter combination allow the image acquisition device to communicate in a wireless communication network, but it would also offer the option of positioning the image acquisitions device by means of for example triangulation and thereby determining the geographical position of the image acquisition equipment. Also, the geographical position of the video equipment may be determined by means of other entities in the wireless communication network and be received at the receiver/transmitter combination as geographical position data of the image acquisition equipment. This would have the advantage of a cheaper solution, since other positioning means still are more expensive, such as, for example satellite positioning.

The processing unit may also be adapted for compressing the recorded moving images and for storing them onto the memory. Using compression, the amount of space taken by the recording of the moving images in the memory may be reduced drastically.

It may also be added that the image acquisition device according to the present invention may be a portable electronic device or even a portable communication device. More specifically, the portable communication device may comprise a cellular telephone. The portability and especially the communication capability of the image acquisition equipment may have the advantage of being able to take the image acquisition equipment everywhere and also to facilitate the transfer the recorded moving images to a geographical map service without being forced to connect the device to a personal computer first.

Another aspect of the present invention is related to a method for acquiring moving images comprising the steps:

starting the acquisition of moving images;

receiving positioning data indicative of the geographical position of the equipment for acquiring the moving images

calculating the current geographical coordinates of the equipment for acquiring the moving images during the recording of the moving images; and

associating the current calculated geographical position with the current time of recording of the moving images.

It should be mentioned here that the calculated geographical coordinates may be continuously or intermittently added to the recording of the moving images.

Moreover, the method according to the present invention is specially suited to be implemented by the image acquisition device according to the present invention.

One other aspect of the present invention is related to a method for storing supplementary data related to recorded moving images comprising the steps: receiving recorded moving images;

extracting one or more meta-tags indicative of the geographical location of the equipment for acquiring moving images from the recorded moving images;

comparing previously stored meta-tags associated with previously stored moving images with the currently extracted meta-tags; and

concatenating the previously stored moving images associated with the previously stored metadata and the currently received recorded moving images associated with the currently received meta-tags.

Finally, another aspect of the present invention is related to a computer program for acquisition of moving images comprising instruction sets for:

starting the acquisition of moving images;

receiving positioning data indicative of the geographical position of the equipment for acquiring the moving images;

calculating the current geographical coordinates of the equipment for acquiring the moving images during the recording of the moving images; and

associating the current calculated.

The computer program is especially suited for implementing the method steps of a method for acquiring moving images according to the present invention.

These and other advantages will become more apparent when studying the detailed description and the accompanying figures.

### BRIEF DESCRIPTION OF THE DRAWINGS

FIG. 1 illustrates a geo-tagged image displayed by an interactive map service according to known technology.

FIG. 2 displays a meta-tagged video recording according one embodiment of the present invention displayed by an interactive map service.

FIG. 3 displays a meta-tagged video recording according to a second embodiment of the present invention displayed by an interactive map service.

FIG. 4 illustrates a video acquisition device according to one embodiment of the present invention.

FIG. 5 illustrates a method of meta-tagging a video recording according to one embodiment of the present invention.

FIG. 6 illustrates a method of storing a meta-tagged video recording.

### DETAILED DESCRIPTION OF PREFERRED EMBODIMENTS

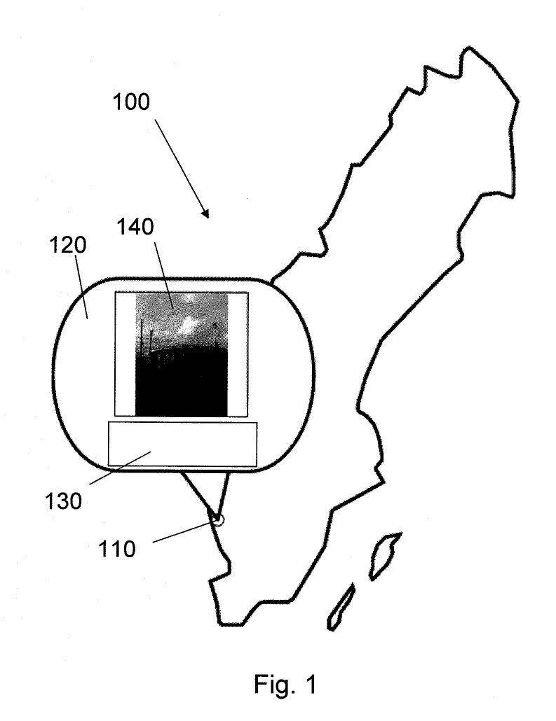

FIG. 1 illustrates a geographical map 100 as provided by known interactive map services. On the map 100, a location 110 is marked by a circle identifying the geographical location where a photograph 140 was taken. Usually the location 110 is either clickable or can be pointed at by means of a mouse cursor. After clicking or pointing on the location an information dialog, such as the dialog 120, may pop up displaying a photograph taken at the location 110 and optionally also some further data or comments 130 in the information dialog 120. The way the interactive map services know where to locate the photograph 140 on the map 100 is by means of so called meta-tags in the image file which specify the coordinates of the location where the photograph was taken and optionally the date and time. However, since an image is inherently static, it may only give a rough idea about the location which was photographed to a user of the interactive map service.

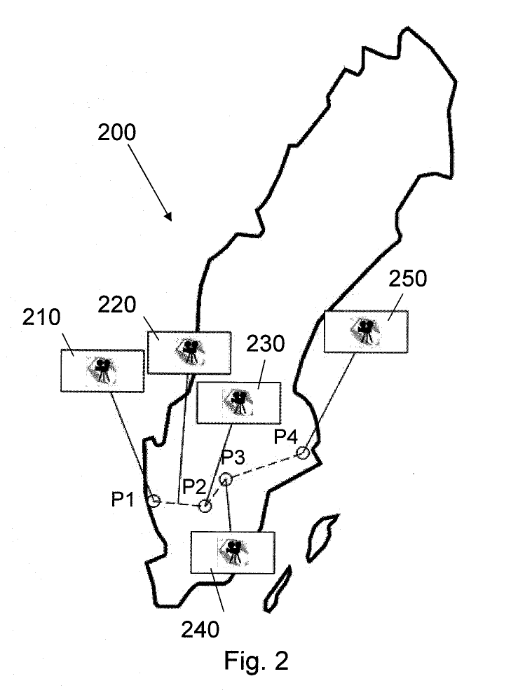

FIG. 2 on the other hand, illustrates a map 200 comprising meta-tags according to a first embodiment of the present invention. The map 200 shows a view identical to the one displayed in FIG. 1 for better comparison. On the map 200, a route is depicted by a broken line, where the route comprises the locations P1, P2, P3 and P4 which may represent different cities along the route or points of interest, such as historical sites, natural views or some other items which may be of interest.

The map 200 also comprises some clickable tags 210, 220, 230, 240 and 250 on the route which are represented by a video equipment symbol. Most of the clickable tags 210, 220, 230, 240 and 250 coincide with the location P1, P2, P3 and P4, but one of them (220) also depicts a time instant on the route between P1 and P2.

As a graphical representation of the video recording, tag symbols 210-250 are depicted on the map 200. Thus, instead of only seeing a static image, a user of the interactive map service according to the present invention may, by clicking one of the tags 210-250, see a whole video sequence which was taken on a specific location or alternatively a set of locations, where the time of recording is marked by the meta-tag. Thus, a user of the interactive map service according to the present invention may get a much more dynamic view of a certain location or number of locations than previously possible.

Now, in contrast to known meta-tags representing one single geographical location and the time of day when the photograph was taken, the meta-tags according to the present invention represent the geographical location where a video recording started and time of the video recording. It should be borne in mind here that the time of recording is a meta-tag different from the time of day. While the time of day basically relates to the time relative to 00:00 AM on a watch, the time of recording meta-tag relates to a time relative to the beginning of the video recording. Thus, for example a meta-tag having the time of recording 00:04:00 depicts that the recording was made four minutes after the original recording started. The time of recording will have special advantages when searching for cities or places located close to the coordinates of the meta-tag. This will be explained more in detail later. It should be added that, as an extra feature, the time of day meta-tag may be added to the time of recording meta-tag. In this fashion a user of the geographical map service may have the option of seeing a video recording of a location in a city or some other location or a number of other locations in different cities during different times of day, such as during daytime or at night. One other additional feature in the meta-tag according to the present invention may be the date and the year of the recording. By means of the year in the meta-tag, a user of the geographical map service may for example see a video recording of the same location made in different years. This may be especially interesting when comparing the same location or stretch of road when the time gap is considerable, such as 10 years or more. Also, by means of the date of recording and the geographical coordinates in the meta-tag of the video recording, a geographical map service where the video recording may be uploaded may determine the season during which the recording was made, such as spring, summer, autumn, winter or even some other type of season if the video recording was made in a part of the world that does not have these four seasons. In this fashion, a user of the geographical map service may also see a video recording made on a certain location or a number of locations during different seasons.

Moreover, if the recording is made from a vehicle in motion, the user of the service interested in getting driving instructions from the interactive map service may also get a much better idea about how to drive, for example, from P1 to P4, since he may recognize certain stretches of the road between P1 and P4.

Meta-tags may by way of example be added using a GPS-receiver in the video equipment which is adapted to register the location coordinates where the video recording started. However the present invention is not only limited to positioning of the video equipment by means of satellites. It may equally be done by means of triangulation or by measuring the strength of a signal received from three or more base stations or access points using an RF-transceiver in the video equipment.

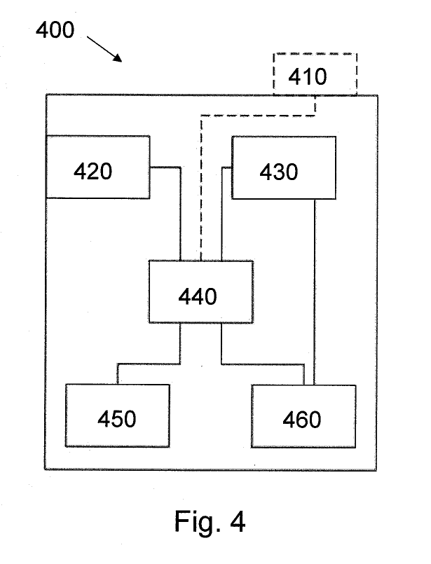

Meta-tags according to the present invention may also be continuously added to the recording. This will be explained more in detail in FIG. 4.

One added feature of the interactive map service according to the present invention may be searchable meta-tags (not shown), whereby the meta-tags in a video file may be associated to certain locations on the map 200 not necessarily being the starting or stopping point of the video recording. Thus, for example, a user searching for a video recording of a location lying between a starting point, such as P1 and an end-point, such as P4 of the video recording may only see a short part of the video recording made at the location he searched instead of being forced to see the entire video recording which may be much longer.

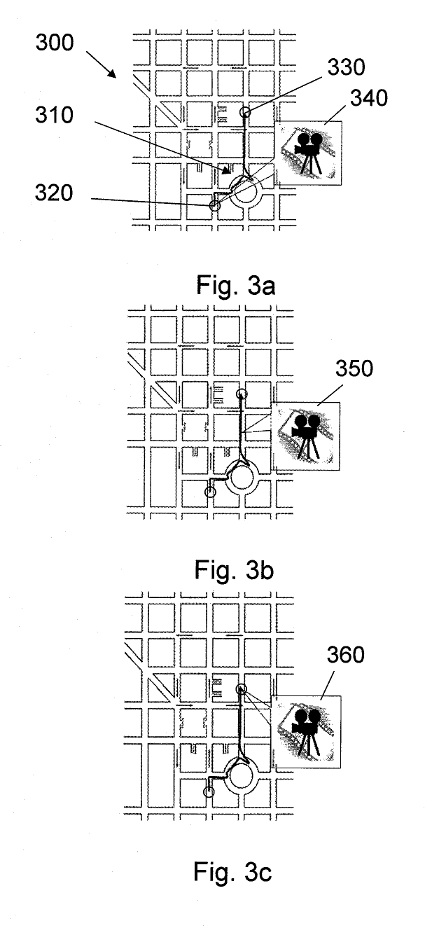

Turning now to FIG. 3a, a road map 300 is shown where a stretch of road 310 shown in black has been passed either by walking, cycling, by a motor vehicle or some other means. Marked by circles, the stretch of road 310 comprises a starting point 320 and an end 330. Similar to the meta-tags in FIG. 2, the meta-tags in this case are marked by a camera sign 330 pointing to the coordinates of a geographical location where the video recording started. Thus, for example, at the very beginning of the journey at 320 a recording 340 was made and the geographical coordinates of the camera as well as the time of recording were registered in the video recording as a meta-data. The coordinates of the camera may be detected by means of a satellite navigation receiver, such as a GPS receiver. Other examples of satellite navigation receivers may comprise GLONASS, GALILEO, BEIDOU and similar navigation receivers. However, as pointed out earlier, the coordinates of the video equipment may also be detected by other means than satellite navigation, presupposing that the camera comprises some sort of RF-transceiver and can be located by means of triangulation or signal strength measurements. As mentioned earlier, meta-tags may be added continuously and automatically during a video recording or set manually by the user of the video equipment. Also, the time of day, date and year of the video recording may be added to the meta-tag.

In FIG. 3b, a second video recording is made displaying a second meta-tag 350 at the location depicted by the video equipment icon. This meta-tag was set between the starting point 320 and the end-point of the video recording 330. Now, in order to add meta-tags to a video recording, a user of the video equipment may select either to set a manual meta-tag in the video recording when the recording is started, by, for example, pressing a button on the video equipment, or by selecting an option in the video equipment where these meta-tags are added automatically in certain time intervals during the course of the video recording. The option to manually set a meta-tag at any moment of time during a recording by, for example, pressing a button on the video equipment, may have the advantage of being able to set a meta-tag at the moment something interesting is seen or seen happening during the video recording.

In FIG. 3c, the end-point of the recording is shown by a circle and a displayed meta-tag 360. The end meta-tag 360 may either be set automatically by the video equipment after a video recording is stopped or manually by the user. It may also be added, that the end meta-tag 360 in FIG. 3c may not necessarily mark the end of the recording, but may be set earlier.

Turning now to FIG. 4, a portable moving picture acquisition device, such as the video equipment 400 according to one embodiment of the present invention is illustrated. The video equipment 400 comprises an optional transmitter/receiver combination 410 marked by a broken line, a satellite navigation receiver 420, an image acquisition unit 430, a processing unit 440, a user interface 450 and a memory 460.

By means of the satellite navigation receiver 420, the video equipment is adapted to receive satellite coordinates from three or more geostationary satellites orbiting the earth. Additionally, the satellite navigation receiver 420 also comprises an internal clock (not shown) for registering the date and time. The navigation receiver may also receiver a clock reference signal from one of the three or more geostationary satellites. This may be useful for more accurate calculations of the geographical location of the video equipment performed later. As mentioned earlier, the processing unit 440 may either calculate or receive the geographical position of the video equipment 400 by means other than satellite positioning, such as triangulation via the receive/transmitter combination 410 and at least three base stations or access points or via signal strength measurements for signals received from three or more base stations or access points.

Using the image acquisition unit 430, the video equipment 400 is adapted to register moving images in the form of a video recording and via the processing unit 440 save the video recording to the memory 460 of the video equipment. One common component for image acquisition today is a CCD-sensor, but also other types of image acquisition units, such as CMOS sensors may be used.

It may be mentioned that the processing unit 440 may either transfer unprocessed moving image data to the memory 460 of the video equipment or be adapted to first execute a compression algorithm on the acquired moving image data before storing it onto the memory 460. Such video compression algorithms are known to the skilled person and will therefore not be elaborated further.

Here, the memory 460 may comprise both an internal and an external memory (not shown), where, for example, a video recording is temporarily stored in the internal memory and after it is finished, transferred onto the external memory of the video equipment 400. This may be useful when capturing smaller size video recordings in the range of tens of megabytes.

Now, by utilizing the user interface 450 which is not shown in detail, a user of the video equipment 400 may send commands to the processing unit 440 in order to activate a certain function in relation to the video recording or the already stored video file. Such functions may, among others, comprise the starting, stopping and pausing of a video recording and adding of meta-tags to the video recording.

In this case, meta-tags may comprise the geographical coordinates of the video equipment 400 together with the time of recording of the video recording.

Now, the user interface 450 may also comprise means for setting a meta-tag during a video recording, by, for example, pressing a special “tag-button” (not shown) on the video equipment. These manually added meta-tags may be treated as special so called “event” tags by the video equipment 400 and marked out as such in the video recording. This would have the advantage when uploading the thus meta-tagged video recording to a geographical map service later, since the service may mark out these “event” tags on the map as special or interesting events.

Returning to FIG. 4, the processing unit 440 may by means of the user interface 450 determine the geographical coordinates of the video equipment by retrieving satellite position data from the satellite navigation receiver 420 and also register the time of recording of the video recording. Using for example triangulation, the processing unit 440 may then calculate the geographical coordinates of the video equipment on the surface of the earth and together with the time of recording add this data as a meta-tag to the video recording in process. It may be mentioned that also the current time of day, date and also year may be registered in the meta-tag added to the video recording.

The user interface 450 may also comprise a text or graphical menu system (not shown) for accessing additional functions provided by the video equipment 400, such as settings for meta-tagging and viewing and deletion of meta-tags.

Settings for meta-tagging of video recordings may comprise alternatives for automatic meta-tagging when a video recording is started and stopped and for selection of the time interval for automatic meta-tagging of a video recording in progress. Following the settings, the processing unit 440 may then at regular time intervals read the satellite position coordinates in order to calculate the geographical position of the video equipment 400 and the time of recording and add it at predefined time intervals to the video recording.

The processing unit 440 is also adapted to store a video recording together with the meta-tags in one video file onto the memory 460 of the video equipment 400 when instructed by the user using a corresponding function of the user interface 450.

Optionally, the video equipment 400 according to the present invention may also comprise an RF receiver/transmitter combination 410 for providing communication in a wireless communication network, such as a GSM/GPRS, NMT, UMTS, CDMA2000, WCDMA, HSDPA, 3GPP-LTE, IEEE 802.11x-type wireless network, HiperLAN/1, HiperLAN/2 and other types of wireless communication networks. The presence of the RF receiver/transmitter combination 410 may have the additional advantage of providing the possibility of transmitting the videos recorded and stored in the memory 460 of the video equipment 400 to a storage server storing the interactive map service. In this fashion, the recorded and possibly meta-tagged video files may be rapidly available for viewing and searching via the interactive map service and be visible via tags on the geographical map displayed by the service. Thus, the video equipment 400 comprising the optional RF receiver/transmitter combination 410 may also act as a mobile terminal.

The RF receiver/transmitter combination may also be used for determining the geographical coordinates of the video equipment 400. However, the accuracy of the coordinate determination may be less precise comparing to the geographical coordinate determination using the signal from the satellite navigation receiver 420.

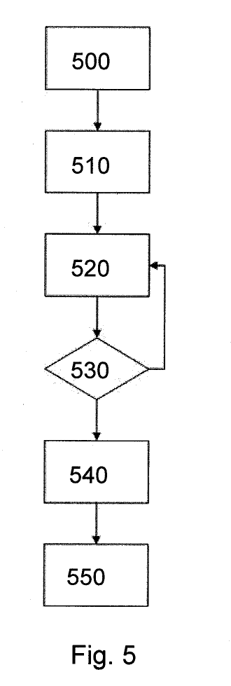

Next, method steps according to one embodiment of the method of the present invention will be described in FIG. 5.

At step 500, a user defines by means of the user interface of the video equipment, such as the video equipment 400 from FIG. 4, initial parameters related to meta-tagging of the video recording. By for example using the text or graphical part of the user interface, such as the user interface 450 in FIG. 4, a user may define automatic meta-tagging and the time interval with which the meta-tags are added to the video recording. In this fashion, the meta-tags will reflect a video-recording as opposed to only one static picture at a time. Another advantage of the continuous meta-tagging is the ability to register coordinates of a location between a starting and a stop point of a video recording. Using an interactive map service or a computer software providing access to the service, these meta-tags can be made visible and clickable on a map and also made searchable. Thus, a user of the geographical map service may search and find a part of a video recording which is of interest to him and which coincides with the geographical coordinates of a location he is searching. A user would therefore not need to see the entire video recording, but only the small part of interest.

Thereafter, at step 510, the user may by means of the user interface instruct the processing unit, such as the processing unit 440 from FIG. 4 to start receiving moving image data from the image capturing unit, such as the image capturing unit 430 and to record them onto the memory of the video equipment. One example of a memory may be the memory 460 in FIG. 4. As already mentioned earlier, the captured moving image data may be compressed by the processing unit prior to being stored in the memory of the video equipment. This can be used to reduce the amount of storage space occupied by the video recording.

At step 520, the processing unit checks whether the user has stopped the video recording via the user interface. This may for example happen when the user presses a stop button on the camera or selects the “stop” option from the text or graphical user interface.

If the video recording is still ongoing, the processing unit continues to add meta-tags to it at user-defined or default intervals. It should be mentioned here, that the video equipment may be adapted to let a user manually add geo-tags to the ongoing video recording at any time. Thus, if a user spots some interesting event, item, scenery or object, he may register its location.

If the video recording has been stopped, the processing unit 440 instructs the image acquisition unit 430 at step 540 to stop the image capturing process, to receive satellite coordinate data from the GPS-receiver and to calculate the geographical coordinates of the video equipment as a sort of “stop coordinates” for the video recording.

Thereafter, at step 550, the processing unit adds the stop coordinates as a geo-tag to the video recording and stores video recording in the memory of the video equipment.

Depending on the size of the internal memory, the processing unit may store the geo-tagged video recording in the form of a video file in the internal memory of the video equipment. However, should the space occupied by the video recording exceed the size of the available internal memory, the video recording may also be stored directly in the external memory of the video equipment.

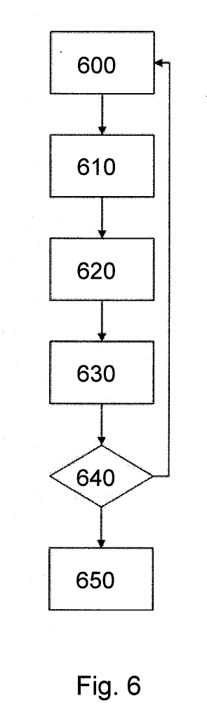

Next, an embodiment of a method for processing the stored and geo-tagged video recordings will be described in more detail in FIG. 6.

At step 600, a processing unit of the interactive map service receives the video recording comprising meta-tags. Thereafter, at step 610, the processing unit stores the video recording in an appropriate storage space and identifies and extracts the meta-tags from the video recording storing them in another part of the same storage space or in some different data storage, such as a cache, internal or external memory.

Using the extracted meta-tags from the video recording, the processing unit at step 620 associates the meta-tags with corresponding geographical locations on a map, such as nearby cities, or, when inside a city, with different city areas or streets as well as points of interest, geographical areas and so on.

Next, at step 630, the processing unit of the interactive map service searches its storage space of previously stored meta-tags in order to find out if there are any matching meta-tags. “Matching” meta-tags may be defined as meta-tags having their geographical latitude and longitude within a predefined interval.

If at step 640, the processing unit has determined that there is such a match, an association is stored between the meta-tag of the current video recording and the meta-tag of the previously stored video recording at step 650. In such a way, when a user of the interactive map service searches for a location on the map and discovers that there is a video recording present from the location, he may choose to view the first video recording. If there was another video recording with matching tags, the geographical service may simply continue to show a second video recording after the first video recording has stopped. However, this may be user selectable. One advantage of the “concatenation” of video recordings in this fashion becomes evident when searching for driving directions from point A to point B, where there may exist several video recordings from A to B but from different parts of the route. If the video recordings have matching meta-tags, they may simply be shown as one single video recording. Thus, if there are enough users who upload their video recordings to the interactive map service, the entire world may be portrayed by moving pictures.

If on the other hand, no match was found between the meta-tags extracted at step 610 and previously stored meta-tags, the method simply returns to step 600 where a new video recording may be received.

It may be added that the meta-tags extracted from the video recording at step 610 may be displayed on a map provided by the interactive map service, of which the map in FIG. 2 is one example. A user may then by clicking on a graphical symbol representing the meta-tag, such as the symbols 210-250, play a video recording which started at that location. One other possibility for a user of the interactive map service according to the present invention may be to click on one of the graphical symbols and drag it along a route, such as the route 310 in FIG. 3a while at the same time playing a video recording made along the route. In this way, the presentation of a stretch of road can be made much more lively then simply seeing a coloured line and some static images along the way.

Finally, it may be said that the above example embodiments of the present invention are illustrative only and should not be taken as limitations. For example, the present invention may not only be applied to interactive map services of the geographical type, but to essentially any mapping service where meta-tagged video-recordings comprising position data and time of recording may be useful.

Thus, the present invention is only limited by the scope and spirit of the accompanying claims.

1-23. (canceled)

24. An imaging device, comprising:
a sensing unit to register video images;
a positioning receiver to receive data indicative of a geographical position of the imaging device; and
a processing unit to calculate a current geographical position of the imaging device from the data received by the positioning receiver and to record the video images,
wherein the processing unit is configured to calculate the current geographical position of the imaging device during the recording of the video images and to associate the current calculated geographical position with a current time of the recording of the video images.

25. The imaging device of claim 24, wherein the processing unit is further configured to convert the current geographical position and the associated time of recording of the video images to metadata.

26. The imaging device of claim 25, wherein the processing unit is further configured to convert geographical height, data, and time of day to the metadata.

27. The imaging device of claim 25, wherein the processing unit is further configured to add the metadata to the recording of the video images.

28. The imaging device of claim 27, wherein the processing unit is configured to contemporaneously add metadata indicative of the current geographical position of the imaging device during the recording of the video images.

29. The imaging device of claim 27, wherein the processing unit is configured to intermittently add metadata indicative of the current geographical position of the imaging device during the recording of the video images.

30. The imaging device of claim 24, further comprising:
a memory to store the recorded video images and the metadata.

31. The imaging device of claim 30, wherein the memory comprises internal data storage or external data storage.

32. The imaging device of claim 30, wherein the processing unit is configured to store the recorded video images and the metadata together in a first data file in the memory.

33. The imaging device of claim 30, wherein the processing unit is configured to store the recorded video images and the metadata in separate data files in the memory.

34. The imaging device of claim 24, further comprising:
a user interface to instruct the processing unit to calculate the geographical position of the imaging device and associate the current geographical position to the time of the recording of the video images.

35. The imaging device of claim 34, wherein the user interface comprises at least one of functional buttons or a text and graphical user interface.

36. The imaging device of claim 24, further comprising:
a transceiver to receive and send signals in a wireless communication network.

37. The imaging device of claim 36, wherein the processing unit is configured to receive geographical position data via the transceiver.

38. The imaging device of claim 24, wherein the processing unit is configured to compress the recorded video images and store the compressed video images in memory.

39. The imaging device of claim 24, wherein the imaging device comprises a portable electronic device.

40. The imaging device of claim 24, wherein the imaging device comprises a portable communication device.

41. The imaging device of claim 40, wherein the portable communication device comprises a cellular telephone.

42. In an imaging device, a method comprising:
recording a plurality of video images;
receiving positioning data indicative of a geographical position of the imaging device;
calculating current geographical coordinates of the imaging device during the recording of the video images; and
associating the current geographical position with a current time of the recording of the video images.

43. The method of claim 42, wherein the current geographical coordinates are contemporaneously added to the recording of the video images.

44. The method of claim 42, wherein the current geographical coordinates are intermittently added to the recording of the video images.

45. In an imaging device, a method of storing data related to recorded video images, comprising:
receiving the recorded video images;
extracting one or more meta-tags indicative of a geographical location of the imaging device from the recorded video images;
comparing previously stored meta-tags associated with previously stored video images with the extracted one or more meta-tags; and
concatenating the previously stored video images associated with the previously stored metadata and the received recorded video images associated with the one or more meta-tags.

46. A computer-executable program for video imaging, comprising:
instructions to start the video images in an imaging device;
instructions to receive positioning data indicative of a geographical position of the imaging device;
instructions to calculate current geographical coordinates of the imaging device during the recording of the video images; and
instructions to associate the current geographical position with a current time of the recording of the video images.
